(19) United States
(12) Patent Application Publication
(10) Pub. No.: US 2024/0035852 A1
(43) Pub. Date: Feb. 1, 2024

(54) SENSOR MODULE AND VEHICLE

(71) Applicant: ROHM CO., LTD., Kyoto (JP)

(72) Inventor: Yuji KANEDA, Kyoto (JP)

(21) Appl. No.: 18/484,754

(22) Filed: Oct. 11, 2023

Related U.S. Application Data
(63) Continuation of application No. PCT/JP2022/018263, filed on Apr. 20, 2022.

(30) Foreign Application Priority Data
Apr. 21, 2021 (JP) 2021071585

(51) Int. Cl. G01D 3/036

(52) U.S. Cl. CPC G01D 3/0365

(57) ABSTRACT

A sensor module includes: a sensor; a semiconductor device including a driver configured to drive the sensor and a processor configured to process the output signal of the sensor; a switcher configured to switch whether or not to cut off or disable the feeding of the output signal of the sensor to the processor; a memory configured to store temperature correction schemes on a non-volatile basis; and a controller configured to perform temperature correction on the driver and the processor based on the temperature correction schemes.

### CROSS-REFERENCE TO RELATED APPLICATIONS

This nonprovisional application is a continuation application of International Patent Application No. PCT/JP2022/018263 filed on Apr. 20, 2022, which claims priority Japanese Patent Application No. 2021-071585 filed in Japan on Apr. 21, 2021, the entire contents of which are hereby incorporated by reference.

### BACKGROUND OF THE INVENTION

### 1. Technical Field

The invention disclosed herein relates to sensor modules and vehicles.

### 2. Description of Related Art

Various sensor modules that include a sensor and a semiconductor device have been developed (see, for example, JP-A-2019-192702). The semiconductor device includes a driver for driving the sensor and a processor for processing the output of the sensor.

### BRIEF DESCRIPTION OF THE DRAWINGS

FIG. 1 is a diagram showing an outline of the configuration of a sensor module according to one embodiment.

FIG. 2 is a diagram showing a first configuration example of the sensor module according to one embodiment.

FIG. 3 comprises graphs showing one example of a temperature correction scheme with respect to the output offset of a processor alone, a temperature correction scheme with respect to the output offset of a driver, and a temperature correction scheme with respect to the output offset of a sensor.

FIG. 4 comprises graphs showing another example of a temperature correction scheme with respect to the output offset of a processor alone, a temperature correction scheme with respect to the output offset of a driver, and a temperature correction scheme with respect to the output offset of a sensor.

FIG. 5 is a diagram showing a second configuration example of the sensor module according to one embodiment.

FIG. 6 is a diagram showing a third configuration example of the sensor module according to one embodiment.

FIG. 7 is a diagram showing a fourth configuration example of the sensor module according to one embodiment.

FIG. 8 is an exterior view of a vehicle according to one embodiment.

### DETAILED DESCRIPTION

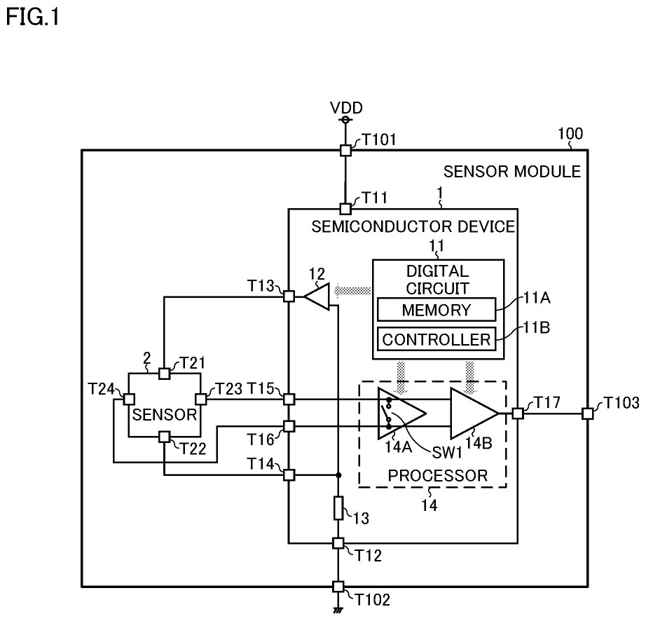

FIG. 1 is a diagram showing an outline of the configuration of a sensor module according to one embodiment. The sensor module 100 shown in FIG. 1 includes a semiconductor device 1, a sensor 2, and terminals T101 to T103.

The semiconductor device 1 is, for example, an LSI (large-scale integration). The semiconductor device 1 includes a digital circuit 11, a driver 12, a resistor 13, a processor 14, and terminals T11 to T17. Thus, the sensor module 100 includes the driver 12 and the processor 14.

The sensor 2 collects information on a sensing target, converts the collected information into an electrical signal, and outputs the electrical signal. The sensor 2 includes terminals T21 to T24. There is no particular limitation on the sensing target of the sensor 2, which can be anything other than temperature. While there is no limitation on the format of the output signal of the sensor 2, in this embodiment the sensor 2 outputs differential voltage signals. The semiconductor device 1 and the sensor 2 are produced by separate processes. For example, the semiconductor device 1 is produced by a silicon semiconductor process and the sensor 2 is produced by a compound semiconductor process.

The terminal T101 is a terminal configured to be fed with a supply voltage VDD, and is physically and electrically connected to the terminal T11 inside the sensor module 100.

The terminal T102 is a terminal configured to be connected to a ground potential, and is physically and electrically connected to the terminal T12 inside the sensor module 100.

The terminal T103 is a terminal configured to feed out the output signal of the processor 14 as will be described later, and is physically and electrically connected to the terminal T17 inside the sensor module 100.

The terminals T13 to T16 are physically and electrically connected to the terminals T21 to T24 respectively inside the sensor module 100.

Next, the blocks in the semiconductor device 1 will be described in detail.

The digital circuit 11 is a circuit that processes digital signals, and controls the operation of the entire sensor module 100. The digital circuit 11 includes a memory 11A and a controller 11B. Thus, the sensor module 100 includes the memory 11A and the controller 11B.

The memory 11A is configured to store temperature correction schemes (details of temperature correction) on a non-volatile basis. The controller 11B is configured to perform temperature correction on the driver 12 and the processor 14 based on the temperature correction schemes stored in the memory 11A.

The driver 12 is configured to drive the sensor 2. The driver 12 outputs a driving current, which is fed via the terminal T13 to the terminal T21 of the sensor 2.

The first terminal of the resistor 13 is physically and electrically connected to the terminal T14 inside the semiconductor device 1, and the second terminal of the resistor 13 is physically and electrically connected to the terminal T12 inside the semiconductor device 1. The resistor 13 converts the driving current to the sensor 2 into a voltage so that a voltage corresponding to the driving current to the sensor 2 is fed back to the sensor 2. The driver 12 performs feedback control on the driving current to the sensor 2.

The processor 14 is configured to process the output signals of the sensor 2. The processor 14 includes a first processor 14A and a second processor 14B.

The first processor 14A is configured to receive and process the output signals of the sensor 2. Specifically, the output signals of the sensor 2, which it outputs via its terminals T23 and T24, are fed via the terminals T15 and T16 to the first processor 14A. While the first processor 14A is here a single amplifier, it is not limited to a single amplifier and may instead be configured to have a plurality of amplifiers connected in series.

The second processor 14B receives and processes the output signals of the first processor 14A. The output signal of the second processor 14B is fed via the terminal T17 to the terminal T103. While in FIG. 1 the second processor 14B is a single amplifier, it is not limited to a single amplifier and may instead be configured to have a plurality of amplifiers connected in series.

The first processor 14A includes a switcher SW1 within it. Thus, the sensor module 100 includes the switcher SW1. The switcher SW1 is configured to switch whether or not to disable the feeding of the output signals of the sensor 2 to the processor 14. Specifically, the switcher SW1 is configured to switch whether or not to short-circuit between the terminals T23 and the terminal T24. The switcher SW1 may instead be configured to switch whether or not to cut off the feeding of the output signals of the sensor 2 to the processor 14. For example, the switcher SW1 may be provided not within the first processor 14A but between, at one end, the terminals T15 and T16 and, at the other end, the processor 14 so that the switcher SW1 turns on and off the electrical connection between the terminals T15 and T16 and the processor 14.

Next, the temperature correction in the sensor module 100 will be described.

First, the switcher SW1 disables the feeding of the output signals of the sensor 2 to the processor 14. This allows separation between the temperature characteristics of the semiconductor device 1 and the temperature characteristics of the sensor 2. In a state where the feeding of the output signals of the sensor 2 to the processor 14 disabled, while the ambient temperature of the sensor module 100 is varied, the output signal via the terminal T103 is diverted to an evaluation device as an external device to the sensor module 100. When the output signal via the terminal T103 is diverted to the evaluation device as an external device to the sensor module 100, the terminal T103 of the sensor module 100 and the input terminal of the evaluation device are connected together by a cable or the like. Based on the output signal via the terminal T103, the evaluation device creates a temperature correction scheme with respect to the output offset of the processor 14 alone (the processor 14 proper, the processor 14 on its own).

Subsequently, the temperature correction scheme with respect to the output offset of the processor 14 alone is stored in the memory 11A. Based on the temperature correction scheme with respect to the output offset of the processor 14 alone, the controller 11B performs temperature correction on the second processor 14B and, in a state where the feeding of the output signals of the sensor 2 to the processor 14 is not disabled, while the ambient temperature of the sensor module 100 is varied, the output signal via the terminal T103 is diverted to the evaluation device. Meanwhile, the sensor 2 does not need to be sensing the sensing target (but may be performing so faint sensing that it can be regarded as not being sensing), or may be sensing so large a sensing target that the output signal of the sensor 2 can ignore the output offset of the sensor 2. Based on the output signal via the terminal T103, the evaluation device creates a temperature correction scheme with respect to the output offset of the driver 12.

Then the temperature correction scheme with respect to the output offset of the processor 14 alone and the temperature correction scheme with respect to the output offset of the driver 12 are stored in the memory 11A. Based on the temperature correction scheme with respect to the output offset of the processor 14 alone and the temperature correction scheme with respect to the output offset of the driver 12, the controller 11B performs temperature correction on the driver 12 and the second processor 14B and, in a state where the sensor 2 is not being sensing the sensing target (but may be performing so faint sensing that it can be regarded as not being sensing) and where the feeding of the output signals of the sensor 2 to the processor 14 is not disabled, while the ambient temperature of the sensor module 100 is varied, the output signal via the terminal T103 is diverted to the evaluation device. Based on the output signal via the terminal T103, the evaluation device creates a temperature correction scheme with respect to the output offset of the sensor 2.

The temperature correction scheme with respect to the output offset of the sensor 2 is stored in the Memory 11A. Thus, based on the temperature correction scheme with respect to the output offset of the processor 14 alone, the temperature correction scheme with respect to the output offset of the driver 12, and the temperature correction scheme with respect to the output offset of the sensor 2, the controller 11B can perform temperature correction on the driver 12, the second processor 14B, and the first processor 14A.

Owing to the sensor module 100 including the switcher SW1, it is possible to separate between the temperature characteristics of the semiconductor device 1 and the temperature characteristics of the sensor 2. This makes it easy for the evaluation device as an external device to the sensor module 100 to acquire the temperature correction schemes for the sensor module 100. As a result, the sensor module 100 can perform temperature correction easily. Incidentally, the sensor module 100 may be configured to incorporate the function of the evaluation device described above.

Moreover, owing to the temperature correction schemes stored in the memory 11A including the temperature correction scheme with respect to the output offset of the processor 14 alone, the temperature correction scheme with respect to the output offset of the driver 12, and the temperature correction scheme with respect to the output offset of the sensor 2, it is possible to perform temperature correction for each of the processor 14 alone, the driver 12, and the sensor 2 appropriately.

Moreover, owing to the temperature correction scheme with respect to the output offset of the processor 14 alone, the temperature correction scheme with respect to the output offset of the driver 12, and the temperature correction scheme with respect to the output offset of the sensor 2 corresponding one-to-one to the driver 12, the second processor 14B, and the first processor 14A, it is easy to control temperature correction.

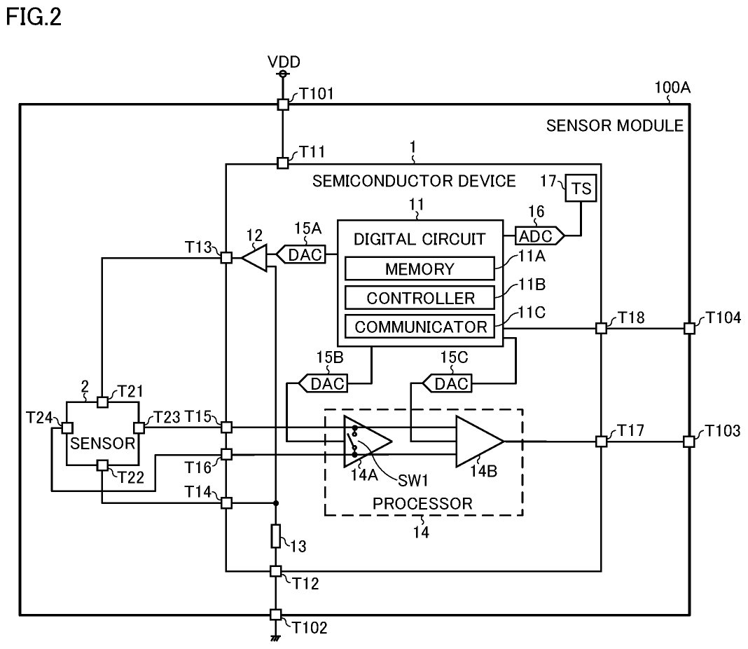

FIG. 2 is a diagram showing a first configuration example of the sensor module 100. The sensor module 100A shown in FIG. 2 includes a terminal T104. The semiconductor device 1 in the sensor module 100A includes DACs (digital-to-analog converters) 15A to 15C, an ADC (analog-to-digital converter) 16, a temperature sensor 17, and a terminal T18. Thus, the sensor module 100A includes the DACs 15A to 15C. Moreover, in the sensor module 100A, the digital circuit 11 includes a communicator 11C.

The controller 11B controls the second processor 14B via the DAC 15C to perform temperature correction with respect to the output offset of the processor 14 alone. The controller 11B controls the driver 12 via the DAC 15A to perform temperature correction with respect to the output offset of the driver 12. The controller 11B controls the first processor 14A via the DAC 15B to perform temperature correction with respect to the output offset of the sensor 2. Owing to the sensor module 100A including the DACs 15A to 15C, the controller 11B can control the second processor 14B, the driver 12, and the first processor 14A with a simple configuration.

The communicator 11C can, via the terminal T18, acquire the signal and information fed to the terminal T104. For example, with the output terminal of the evaluation device mentioned above and the terminal T104 connected together by a cable or the like, the communicator 11C can acquire from the evaluation device the temperature correction scheme with respect to the output offset of the processor 14 alone, the temperature correction scheme with respect to the output offset of the driver 12, and the temperature correction scheme with respect to the output offset of the sensor 2.

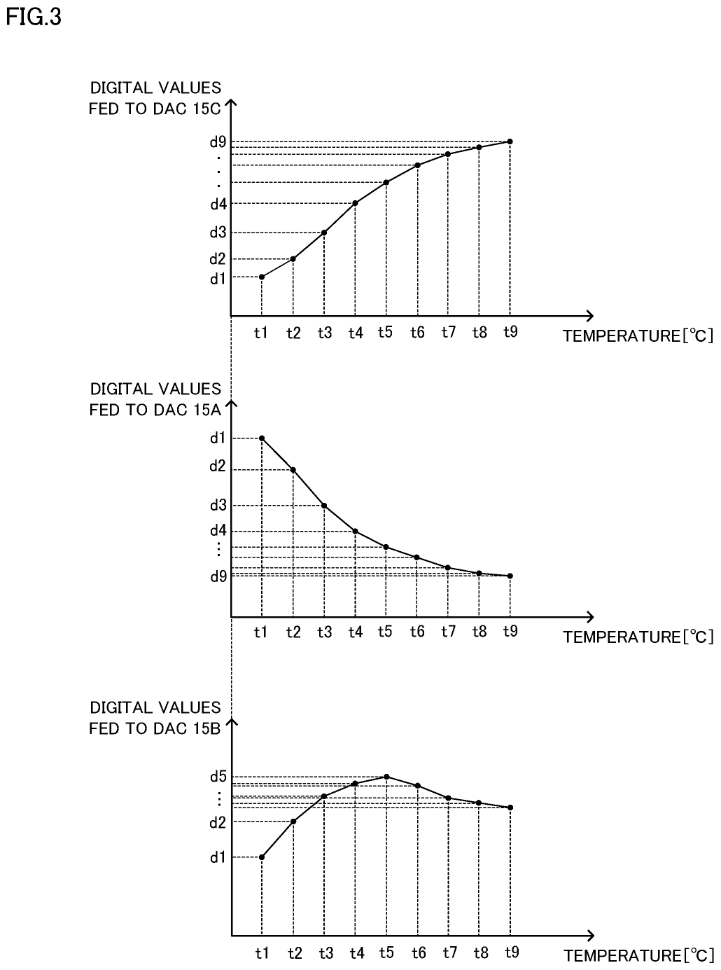

FIG. 3 comprises graphs showing one example of the temperature correction scheme with respect to the output offset of the processor 14 alone, the temperature correction scheme with respect to the output offset of the driver 12, and the temperature correction scheme with respect to the output offset of the sensor 2. In each graph in FIG. 3, the horizontal axis represents temperature. In the top graph in FIG. 3, the vertical axis represents the digital values that the controller 11B feeds to the DAC 15C. In the middle graph in FIG. 3, the vertical axis represents the digital values that the controller 11B feeds to the DAC 15A. In the bottom graph in FIG. 3, the vertical axis represents the digital values that the controller 11B feeds to the DAC 15B.

A data table corresponding to the nine dots in the top graph in FIG. 3 is, as the temperature correction scheme with respect to the output offset of the processor 14 alone, stored in the memory 11A. Between two consecutive dots, digital values are determined by, for example, linear interpolation.

A data table corresponding to the nine dots in the middle graph in FIG. 3 is, as the temperature correction scheme with respect to the output offset of the driver 12, stored in the memory 11A. Between two consecutive dots, digital values are determined by, for example, linear interpolation.

A data table corresponding to the nine dots in the bottom graph in FIG. 3 is, as the temperature correction scheme with respect to the output offset of the sensor 2, stored in the memory 11A. Between two consecutive dots, digital values are determined by, for example, linear interpolation.

While the number of dots in each graph in FIG. 3 is nine, it may be any number other than nine. The number of dots may differ among different graphs.

Among all the graphs in FIG. 3, the value of the first item t1 of temperature data is the same, and so is each of the values of the second to ninth items t2 to t9 of temperature data.

It is here preferable that individual items of temperature data can be set to different values among the temperature correction scheme with respect to the output offset of the processor 14 alone, the temperature correction scheme with respect to the output offset of the driver 12, and the temperature correction scheme with respect to the output offset of the sensor 2. In this way it is possible to concentrate temperature data around inflection points in the graphs and thereby enhance the accuracy of temperature correction around inflection points in the graphs.

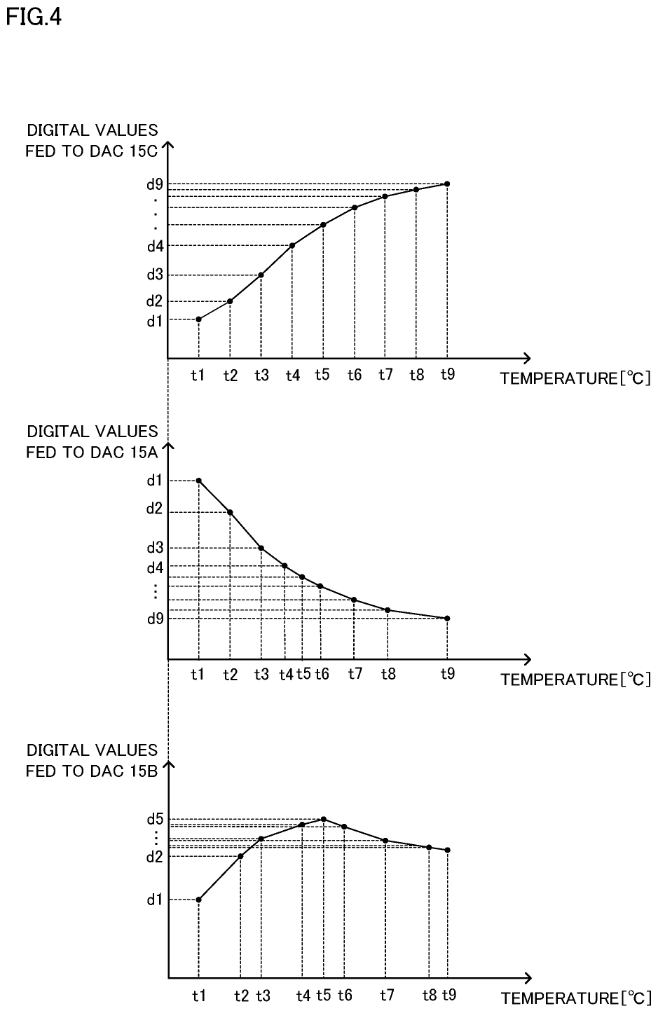

In each graph in FIG. 4, the horizontal axis represents temperature. In the top graph in FIG. 4, the vertical axis represents the digital values that the controller 11B feeds to the DAC 15C. In the middle graph in FIG. 4, the vertical axis represents the digital values that the controller 11B feeds to the DAC 15A. In the bottom graph in FIG. 4, the vertical axis represents the digital values that the controller 11B feeds to the DAC 15B. Among the graphs in FIG. 4, for example, the eighth item t8 of temperature data is set to different values.

Incidentally, the memory 11A may store, instead of data tables, functions that represent the relationships between temperatures and digital values.

As mentioned above, the semiconductor device 1 in the sensor module 100A includes the temperature sensor 17. Thus, the sensor module 100A includes the temperature sensor 17. The output signal of the temperature sensor 17 (i.e., temperature information) is converted by the ADC 16 into a digital signal, which is fed to the digital circuit 11. Based on the temperature correction schemes stored in the memory 11A, the digital circuit 11 performs temperature correction on the driver 12 and the processor 14.

Owing to the sensor module 100A including the temperature sensor 17, there is no need to provide the sensor module 100A with an input terminal for the input of temperature information. This helps reduce the size and the cost of the sensor module 100A.

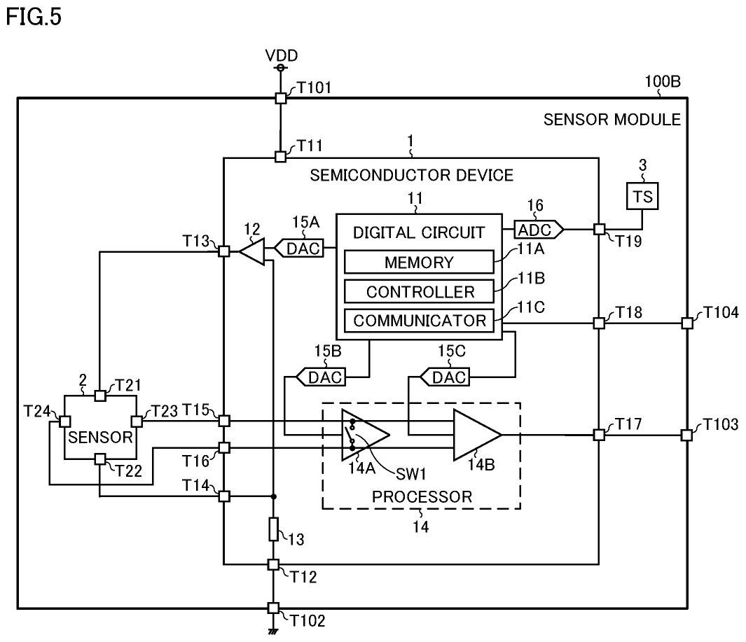

FIG. 5 is a diagram showing a second configuration example of the sensor module 100. The sensor module 100B shown in FIG. 5 differs from the sensor module 100A in that it does not include a temperature sensor within it, and is otherwise basically similar to the sensor module 100A.

The sensor module 100B includes a sensor 3. The semiconductor device 1 in the sensor module 100B includes a terminal T19. The output signal of the sensor 3 (i.e., temperature information) is fed via the terminal T19 to the ADC 16.

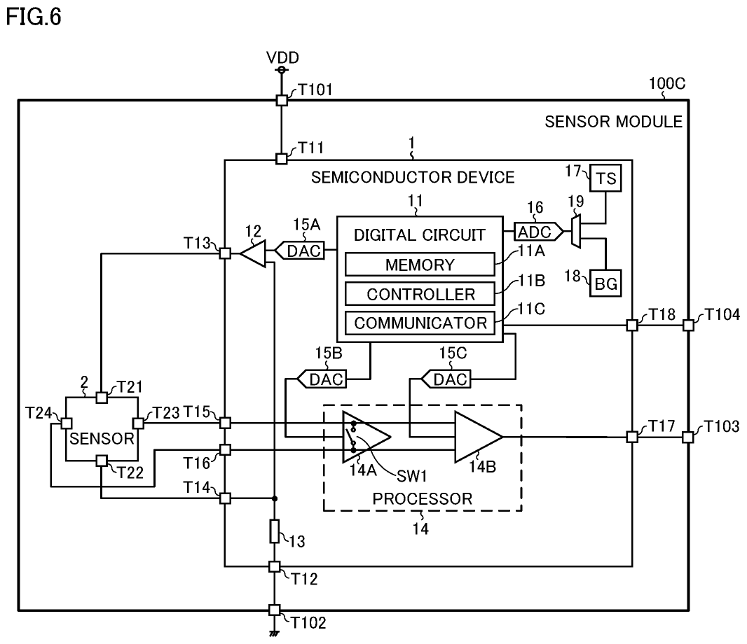

FIG. 6 is a diagram showing a third configuration example of the sensor module 100. The sensor module 100C shown in FIG. 6 differs from the sensor module 100A in that the semiconductor device 1 includes a constant voltage source 18 and a selector 19, and is otherwise basically similar to the sensor module 100A.

The constant voltage source 18 is configured to output a constant voltage. Here, “constant voltage” denotes a voltage that remains fixed under ideal conditions and it can be a voltage that may in practice vary slightly with variation in temperature. While there is no limitation on the specific circuit configuration of the constant voltage source 18, in this configuration example the constant voltage source 18 is assumed to be a constant voltage circuit of a band gap type.

The output signal of the sensor 17 (i.e., temperature information) is fed to the first input terminal of the selector 19. The constant voltage output from the constant voltage source 18 is fed to the second input terminal of the selector 19.

The selector 19 is configured to choose either the output signal of the sensor 17 or the constant voltage. The ADC 16 converts the output of the selector 19 into a digital signal and feed it to the digital circuit 11. The controller 11B is configured to correct the output signal of the sensor 17 (i.e., temperature information) based on the output of the ADC 16 as it is when the selector 19 is choosing the constant voltage. The selector 19 selects the constant voltage cyclically for a very short period and otherwise selects the output signal of the sensor 17.

With the sensor module 100C, the correction of the temperature information results in enhanced accuracy of the temperature information and hence enhanced accuracy of the temperature correction on the driver and the processor.

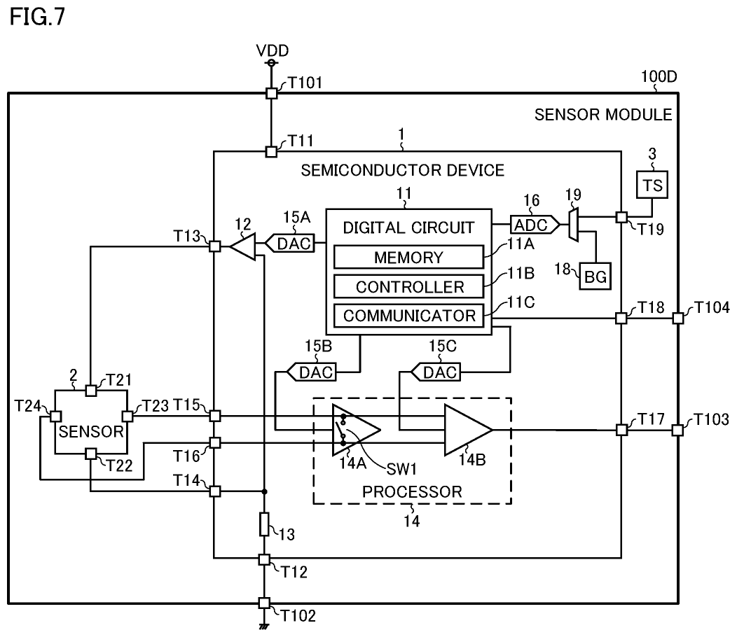

FIG. 7 is a diagram showing a fourth configuration example of the sensor module 100. The sensor module 100D shown in FIG. 7 differs from the sensor module 100C in that the semiconductor device 1 does not include a temperature sensor within it, and is otherwise basically similar to the sensor module 100C.

The sensor module 100D includes a sensor 3. The semiconductor device 1 in the sensor module 100D has a terminal T19. The output signal of the sensor 3 (i.e., temperature information) is fed via the terminal T19 to the first input terminal of the selector 19.

While there is no limitation on the devices and appliances in which the sensor module 100 described above can be incorporated, the sensor module 100 is particularly useful for incorporation in devices and appliances used in environments with large temperature variation.

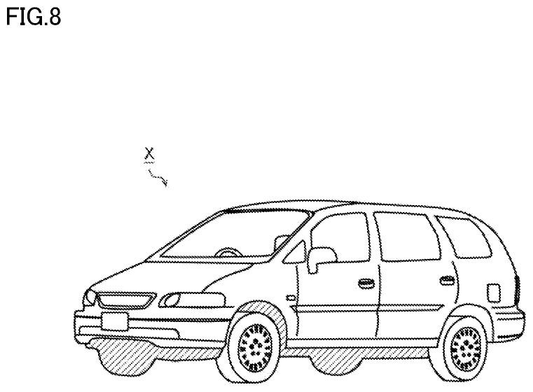

The sensor module 100 is incorporated, for example, in a vehicle X as shown in FIG. 8. That is, the vehicle X incorporates the sensor module 100. In a case where the vehicle X incorporates the sensor module 100, for example, the sensor 2 provided in the sensor module 100 can be, for example, a magnetic sensor, and the rotor rotation position of a predetermined motor provided on the vehicle X can be sensed based on the sensing signal from the magnetic sensor.

The present invention can be implemented with any configuration other than those of the embodiments described above, with any modifications made without departure from the spirit of the present invention. The embodiments described above are to be taken in every way illustrative and not restrictive, and the technical scope of the present invention is defined not by the description of the embodiments given above but by the appended claims and is to be understood to encompass any modifications made within a scope equivalent in significance to what is claimed.

For example, while the sensor modules 100A to 100D described above incorporate a temperature sensor, a temperature sensor may be provided outside a sensor module and temperature information detected by it may be acquired by a controller provided within the sensor module.

According to one aspect of what is disclosed herein, a sensor module (100A-100D) includes: a sensor (2); a semiconductor device (1) including a driver (12) configured to drive the sensor and a processor (14) configured to process an output signal of the sensor; a switcher (SW1) configured to switch whether or not to cut off or disable the feeding of the output signal of the sensor to the processor; a memory (11A) configured to store temperature correction schemes on a non-volatile basis; and a controller (11B) configured to perform temperature correction on the driver and the processor based on the temperature correction schemes. (A first configuration.) The sensor module of the first configuration described above is configured to be able to separate between the temperature characteristics of the semiconductor device and the temperature characteristics of the sensor. The sensor module can thus perform temperature correction easily.

In the sensor module of the first configuration described above, the temperature correction schemes may include a first scheme with respect to the output offset of the processor alone, a second scheme with respect to the output offset of the driver, and a third scheme with respect to the output offset of the sensor. (A second configuration.)

With the sensor module of the second configuration described above, it is possible to perform temperature correction on each of the processor alone, the driver, and the sensor appropriately.

In the sensor module of the second configuration described above, the processor may include: a first processor (14A) configured to receive and process the output signal of the sensor; and a second processor (14B) configured to receive and process the output signal of the first processor. The controller may be configured to perform temperature correction on the second processor based on the first scheme, perform temperature correction on the driver based on the second scheme, and perform temperature correction on the first processor based on the third scheme. (A third configuration.)

With the sensor module of the third configuration described above, owing to the first to third schemes corresponding one-to-one to different control targets for temperature correction, it is easy to control temperature correction.

The sensor module of the third configuration described above may further include a first DAC (15A), a second DAC (15B), and a third DAC (15C). The controller may be configured to perform temperature correction on the second processor via the first DAC, perform temperature correction on the driver via the second DAC, and perform temperature correction on the first processor via the third DAC. (A fourth configuration.) With the sensor module of the fourth configuration described above, owing to its including the first to third DACs, the controller can control the second processor, the driver, and the first processor with a simple configuration.

In the sensor module of any of the second to fourth configurations described above, the first, second, and third schemes may be data tables respectively, and the temperature data in those data tables may be settable to different values among the first, second, and third schemes. (A fifth configuration.)

With the sensor module of the fifth configuration described above, it is possible, for example, to concentrate temperature data around inflection points in the graphs obtained by interpolating the data tables and thereby enhance the accuracy of temperature correction around inflection points in the graphs.

The sensor module of any of the first to fifth configurations described above may further include a temperature sensor (3, 17). The controller may be configured to acquire temperature information detected by the temperature sensor and perform temperature correction on the driver and the processor based on the temperature information and the temperature correction schemes. (A sixth configuration.)

The sensor module of the sixth configuration described above, owing to its incorporating a temperature sensor, does not require an input terminal for the input of temperature information. This helps reduce the size and the cost of the sensor module.

The sensor module of the sixth configuration described above may further include: a constant voltage source (18) configured to output a constant voltage; a selector (19) configured to choose either the output of the temperature sensor or the constant voltage; and an ADC (16) configured to perform analog-to-digital conversion on the output of the selector. The controller may be configured to correct the temperature information based on the output of the ADC yielded when the selector is choosing the constant voltage. (A seventh configuration.)

With the sensor module of the seventh configuration described above, the correction of the temperature information results in enhanced accuracy of the temperature information and hence enhanced accuracy of the temperature correction on the driver and the processor.

According to another aspect of what is disclosed herein, a vehicle (X) includes the sensor module of any of the first to seventh configurations described above. (An eighth configuration.)

With the vehicle of the eighth configuration described above, the sensor module incorporated in it can perform temperature correction easily.

1. A sensor module, comprising:
a sensor;
a semiconductor device including:
a driver configured to drive the sensor; and
a processor configured to process an output signal of the sensor;
a switcher configured to switch whether or not to cut off or disable feeding of the output signal of the sensor to the processor;
a memory configured to store temperature correction schemes on a non-volatile basis; and
a controller configured to perform temperature correction on the driver and the processor based on the temperature correction schemes.

2. The sensor module according to claim 1, wherein
the temperature correction schemes include:
a first scheme with respect to an output offset of the processor alone;
a second scheme with respect to an output offset of the driver; and
a third scheme with respect to an output offset of the sensor.

3. The sensor module according to claim 2, wherein
the processor includes:
a first processor configured to receive and process the output signal of the sensor; and
a second processor configured to receive and process an output signal of the first processor, and
the controller is configured to
perform temperature correction on the second processor based on the first scheme,
perform temperature correction on the driver based on the second scheme, and
perform temperature correction on the first processor based on the third scheme.

4. The sensor module according to claim 3, further comprising a first DAC, a second DAC, and a third DAC, wherein
the controller is configured to
perform temperature correction on the second processor via the first DAC,
perform temperature correction on the driver via the second DAC, and
perform temperature correction on the first processor via the third DAC.

5. The sensor module according to claim 2, wherein
the first, second, and third schemes are data tables respectively, and
temperature data in the data tables can be set to different values among the first, second, and third schemes.

6. The sensor module according to claim 1, further comprising a temperature sensor, wherein
the controller is configured to acquire temperature information detected by the temperature sensor and perform temperature correction on the driver and the processor based on the temperature information and the temperature correction schemes.

7. The sensor module according to claim 6, further comprising:
a constant voltage source configured to output a constant voltage;
a selector configured to choose either an output of the temperature sensor or the constant voltage; and
an ADC configured to perform analog-to-digital conversion on an output of the selector,
wherein
the controller is configured to correct the temperature information based on an output of the ADC yielded when the selector is choosing the constant voltage.

8. A vehicle, comprising the sensor module according to claim 1.

9. A vehicle, comprising the sensor module according to claim 2.

10. A vehicle, comprising the sensor module according to claim 3.

11. A vehicle, comprising the sensor module according to claim 4.

12. A vehicle, comprising the sensor module according to claim 5.

13. A vehicle, comprising the sensor module according to claim 6.

14. A vehicle, comprising the sensor module according to claim 7.
